(19) United States
(12) Patent Application Publication
(10) Pub. No.: US 2014/0078325 A1
(43) Pub. Date: Mar. 20, 2014

(54) IMAGE CAPTURING APPARATUS AND CONTROL METHOD THEREFOR

(71) Applicant: CANON KABUSHIKI KAISHA, Tokyo (JP)

(72) Inventors: Minoru Sakaida, Yokohama-shi (JP); Ken Terasawa, Yokohama-shi (JP)

(73) Assignee: CANON KABUSHIKI KAISHA, Tokyo (JP)

(21) Appl. No.: 14/019,045

(22) Filed: Sep. 5, 2013

(30) Foreign Application Priority Data
Sep. 19, 2012 (JP) 2012-206313

(51) Int. Cl. H04N 5/232

(52) U.S. Cl. CPC H04N 5/232
USPC 348/208.4; 348/211.99

(57) ABSTRACT

An image capturing apparatus capable of operating an imaging unit in a plurality of shooting modes is provided. In response to designation of one or more keywords related to a shooting scene by a user, one or more of the plurality of shooting modes, which correspond to the one or more keywords, are selected. In shooting, a shooting scene is determined based on an image signal generated by the imaging unit. Shooting parameters are generated based on the one or more selected shooting modes and the determined shooting scene. The operation of the imaging unit is controlled using the generated shooting parameters.

### BACKGROUND OF THE INVENTION

1. Field of the Invention

The present invention relates to an image capturing apparatus and a control method therefor.

2. Description of the Related Art

Conventionally an image capturing apparatus represented by a digital camera has shooting modes corresponding to a plurality of shooting scenes, such as a portrait mode, landscape mode, and night view mode. A user can set shooting parameters such as a shutter speed, aperture value, white balance, γ coefficient, and edge enhancement in a state appropriate for an object by selecting, in advance, a shooting mode corresponding to a shooting scene.

In recent years, there has been developed a technique of recognizing a shooting scene by analyzing the characteristics of a video signal, and automatically setting an appropriate one of a plurality of shooting modes (see, for example, Japanese Patent Laid-Open No. 2003-344891).

In movie shooting according to Japanese Patent Laid-Open No. 2003-344891, a shooting mode may not be changed as intended by the user due to erroneous determination of a shooting scene, and thus a video cannot be stored with a desired image quality.

Some of shooting modes produce an effect on only a specific shooting scene such as a sunset, snow, or beach. If such shooting mode effective for a specific shooting scene is unwantedly selected due to erroneous determination of a shooting scene, a video largely different from a desired one may be stored. In movie shooting according to Japanese Patent Laid-Open No. 2003-344891, some shooting modes are not selection candidates, and the user needs to directly set a shooting mode according to a shooting scene.

### SUMMARY OF THE INVENTION

The present invention reduces the possibility of erroneous determination of a shooting scene, and increases the degree of freedom of selection of a shooting mode, thereby realizing shooting by preferable camera control reflecting user's intention.

According to one aspect of the present invention, there is provided an image capturing apparatus which includes an imaging unit configured to generate an image signal by causing an image sensor to photoelectrically convert an object image formed by an imaging optical system, and is capable of operating the imaging unit in a plurality of shooting modes, comprising: a setting unit configured to set at least one keyword related to a shooting scene, which has been designated by a user; a selection unit configured to select at least one of the plurality of shooting modes, which corresponds to the at least one set keyword; a determination unit configured to determine a shooting scene based on the image signal generated by the imaging unit; a generation unit configured to generate shooting parameters based on the at least one selected shooting mode and the determined shooting scene; and a control unit configured to control an operation of the imaging unit using the generated shooting parameters.

Further features of the present invention will become apparent from the following description of exemplary embodiments (with reference to the attached drawings).

### BRIEF DESCRIPTION OF THE DRAWINGS

FIG. 1 is a block diagram showing the arrangement of an image capturing apparatus according to an embodiment;

FIG. 2 is a flowchart illustrating a shooting control procedure in scenario setting according to the embodiment;

FIGS. 3A and 3B are views each showing an example of a scenario setting screen in the image capturing apparatus according to the embodiment;

FIG. 4 is a flowchart illustrating a control procedure associated with scenario setting according to the embodiment;

FIG. 5 is a table showing the correspondence between keywords for respective items and shooting mode candidates;

FIG. 6 is a view for explaining an example of selection of keywords and decision of shooting mode candidates;

FIG. 7 is a flowchart illustrating a procedure of deciding a shooting mode according to the embodiment;

FIG. 8 is a block diagram showing the arrangement of the image capturing apparatus according to another embodiment;

FIG. 9 is a flowchart illustrating a shooting control procedure in scenario setting according to the other embodiment;

FIG. 10 is a table showing the correspondence between keywords for respective items and shooting assistant functions;

FIG. 11 is a flowchart illustrating a zoom control procedure according to the other embodiment; and

FIG. 12 is a graph showing zoom control according to the other embodiment.

### DESCRIPTION OF THE EMBODIMENTS

Various exemplary embodiments, features, and aspects of the invention will be described in detail below with reference to the drawings.

Note that the present invention is not limited to the following embodiments, which are merely examples advantageous to the implementation of the present invention. In addition, not all combinations of characteristic features described in the embodiments are essential to the solution of the problems in the present invention.

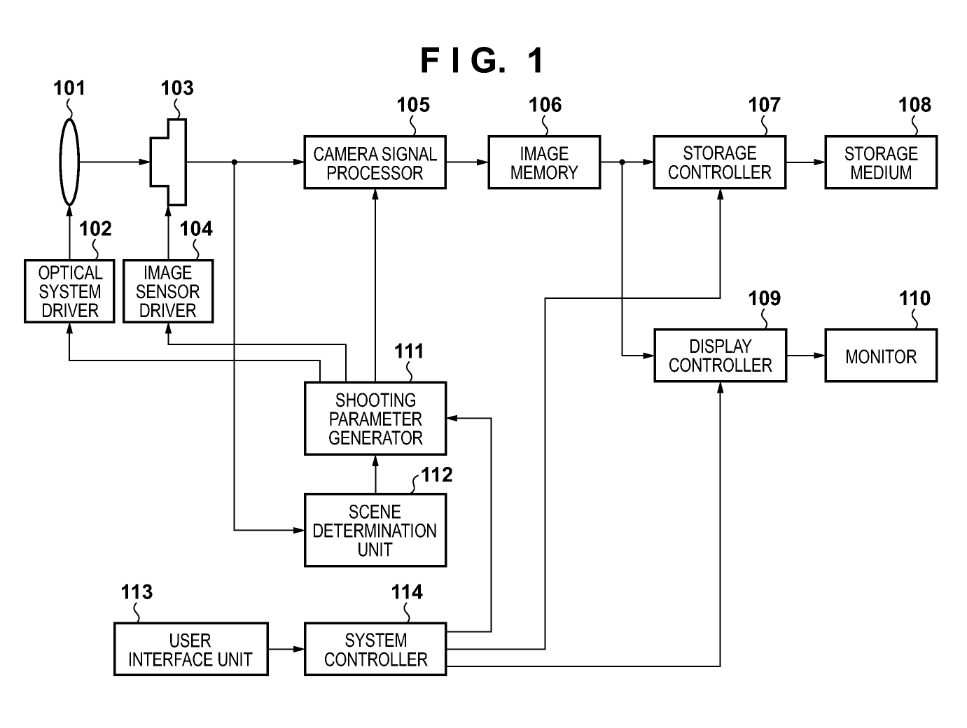

FIG. 1 is a block diagram showing an example of the arrangement of an image capturing apparatus according to an embodiment. An imaging optical system 101 causes an optical system driver 102 to control the aperture value, focus, zoom, and the like based on control information from a shooting parameter generator 111, thereby forming an object image on an image sensor 103. The image sensor 103 is driven by a driving pulse generated by an image sensor driver 104, and converts the object image into an electrical signal by photoelectrical conversion to output it as an image signal.

The image signal is input to a camera signal processor 105. The camera signal processor 105 generates image data by performing camera signal processing such as white balance processing, edge enhancement processing, and γ correction processing for the input image signal, and writes the generated image data in an image memory 106.

A storage controller 107 reads out the image data from the image memory 106, generates image compression data by compressing the readout image data by a predetermined compression scheme (for example, an MPEG scheme), and then stores the generated data in a storage medium 108.

If the user wants to display an image on a monitor 110 without storing the image, a display controller 109 reads out the image data written in the image memory 106, and performs image conversion for the monitor 110, thereby generating a monitor image signal. The monitor 110 then displays the input monitor image signal.

Control of the image capturing apparatus according to the embodiment will be explained next.

The user can instruct, via a user interface unit 113, to switch the shooting mode of the image capturing apparatus, create a scenario, change display contents on the monitor 110, and change other various settings. Based on information from the user interface unit 113, a system controller 114 controls the operation of the storage controller 107, display controller 109, and shooting parameter generator 111, and controls the data flow. The information input from the user interface unit 113 to the system controller 114 includes scenario settings (to be described later). In addition, the information can include direct designation of a shooting mode, manual setting of the shooting parameters, designation of a stored video format by the storage controller 107, and display of a stored video in the storage medium 108. In response to an instruction from the user interface unit 113, the display controller 109 switches among a shooting screen, setting screen, and playback screen.

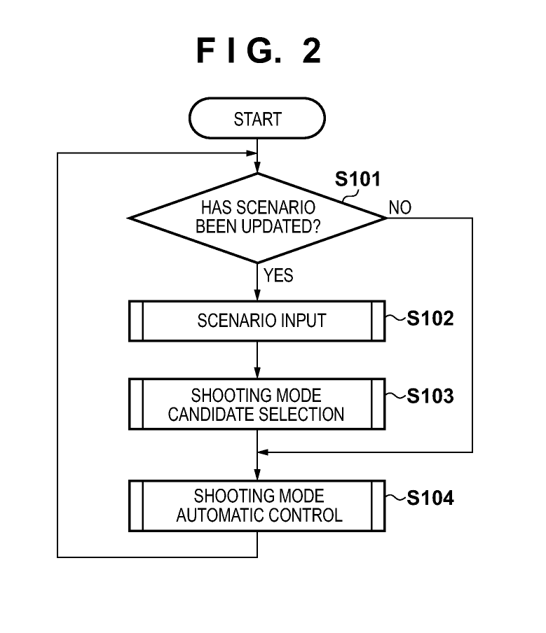

A shooting control procedure in scenario setting according to the embodiment will be described below with reference to a flowchart shown in FIG. 2.

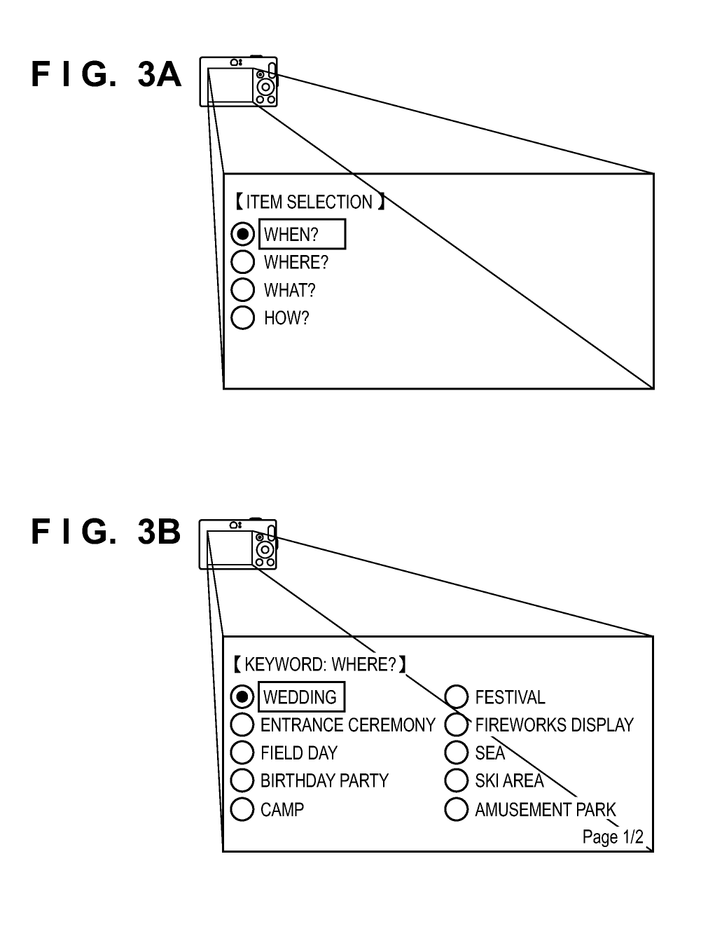

The user can instruct, via the user interface unit 113, to create (or update) a scenario. The system controller 114 monitors a scenario creation or update instruction (step S101). If a scenario creation instruction has been issued, the process advances to step S102. In step S102, the system controller 114 instructs the display controller 109 to display a scenario data setting screen on the monitor 110. With this processing, an item selection screen shown in FIG. 3A is displayed on the monitor 110.

As shown in FIG. 3A, a plurality of scenario items for deciding a scenario are displayed on the screen. The plurality of scenario items include a shooting date (“when”), a shooting location (“where”), a shooting object (“what”), and a shooting method (“how”). The user can select one of the items. When the user selects a scenario item, a screen for selecting a keyword for the selected scenario item is displayed. FIG. 3B shows a keyword selection screen displayed when the user selects the scenario item “where”. The user selects one of a plurality of keyword candidates corresponding to each scenario item in accordance with a shooting purpose. In this way, the user can select one keyword for an arbitrary scenario item, and thus can select one or more keywords for all the scenario items. It is possible to save, as scenario data, a combined result of the selected keywords of the respective scenario items in the storage medium such as a memory card. In this way, the user can create a scenario before shooting.

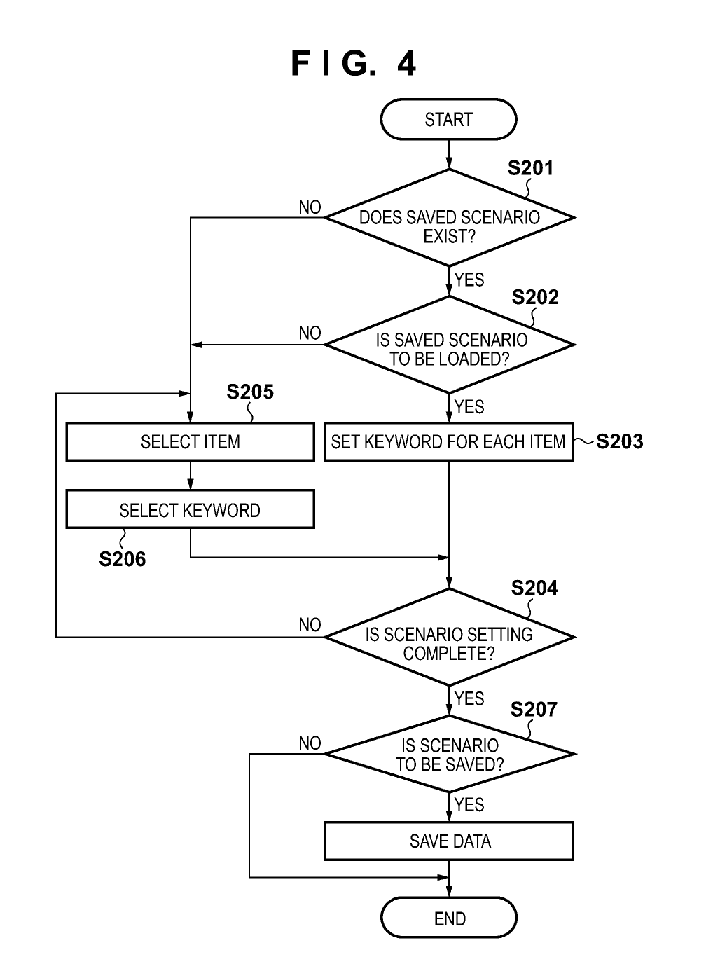

FIG. 4 shows the control procedure of the scenario input processing in step S102.

It is determined whether scenario data exists in the storage medium (step S201). If scenario data exists, whether to use the scenario data is selected based on an instruction from the user (step S202). If the scenario data is to be used, a keyword for each item is set according to the scenario data (step S203). If, for example, the user “shoots a child who is skiing”, he/she designates “winter” for “when”, “ski area” for “where”, “child” for “what”, and “preferentially shoot” for “how to shoot”. If setting of a keyword for each item according to the scenario data is not complete (NO in step S204), the user selects an item according to a shooting situation (step S205), and selects a keyword (step S206). These processes are executed if the scenario data is not saved (NO in step S201) or if the saved scenario is not to be used (NO in step S202).

Upon completion of selection of a keyword for each item, the user selects whether to save a created scenario (step S207). If the scenario is to be saved, the scenario data is stored in the storage medium, and the scenario input processing is terminated.

The detailed procedure of the scenario input processing has been described so far.

Next, the system controller 114 analyzes the scenario data input from the user interface unit 113, and selects shooting mode candidates (step S103). In this embodiment, the scenario data analysis and shooting mode candidate selection processing indicates processing of selecting possible shooting mode candidates for the keywords input in the scenario input processing. The scenario data analysis and shooting mode candidate selection processing will be explained below.

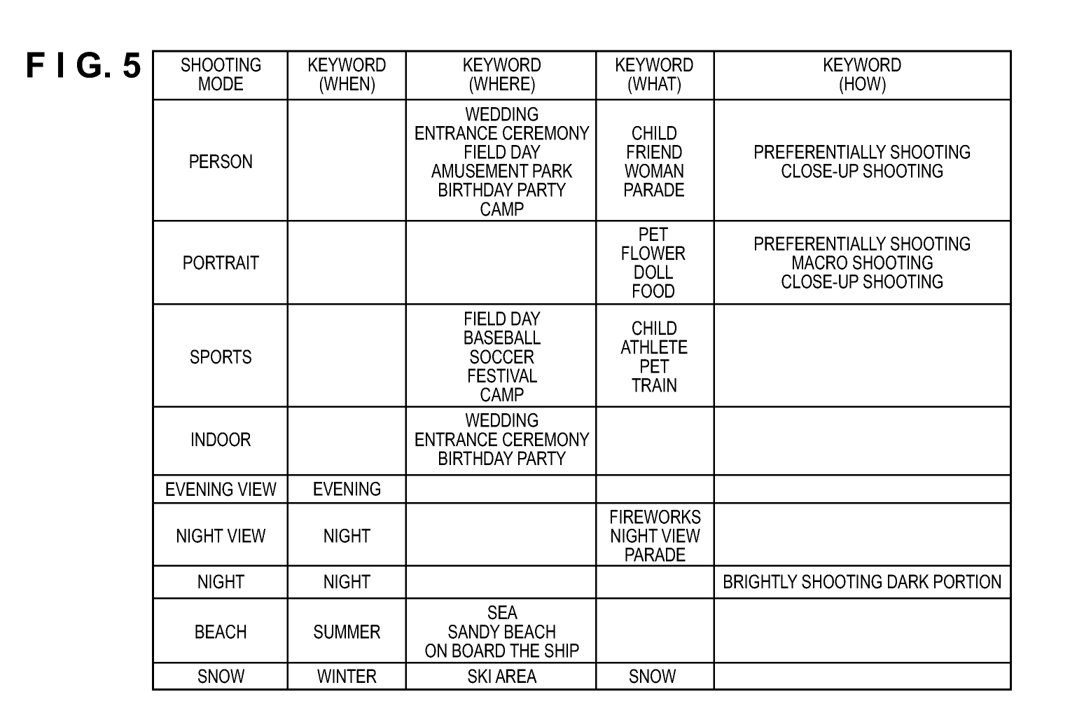

FIG. 5 is a correspondence table between keywords input in the scenario input processing and shooting mode candidates for the keywords. A table showing the correspondence between keywords and shooting modes is generated by deciding, in advance, shooting mode candidates based on a shooting object estimated based on keywords, a shooting time, and required camera works, and is stored in a ROM or the like. Note that the correspondence between keywords and shooting mode candidates may be a many-to-many correspondence, instead of a one-to-one correspondence. If, for example, the user selects “wedding” or “entrance ceremony” for “where”, “person” and “indoor” are selected as shooting mode candidates.

The correspondence between each keyword and shooting mode candidates for the keyword will be described.

For a keyword for the scenario item “when”, the color temperature and illuminance of outdoor sunlight are determined by selecting a shooting time or date. For example, to shoot a sunset, a sunset mode in which the white balance is adjusted to shoot an impressive image of the sunset is selected. Since it is assumed to shoot an object with a high color temperature such as snow in winter, a snow mode corresponding to such shooting is selected. Note that it may be possible to select a more advanced shooting mode candidate by inputting, for the scenario item “when”, a keyword such as “evening in winter” obtained by combining a shooting time and date.

The presence/absence of a person or how to shoot is determined by selecting a shooting location or event as a keyword for the scenario item “where”. In, for example, shooting in a wedding or entrance ceremony, it is assumed that a child is mainly shot, and thus a person mode is selected. Since an indoor shooting scene is also assumed, an indoor mode is also selected. In a field day, many scenes include a moving object such as a running race in addition to shooting of a child, thereby selecting both the person mode and a sports mode. In a ski area, since it is assumed that snow is a shooting object, the snow mode is selected.

By selecting a shooting object as a keyword for the scenario item “what”, a shooting mode candidate appropriate for the shooting object is also selected. If, for example, a child is selected as a shooting object, movement such as running is assumed, and thus the sports mode is also selected so that no motion blur occurs, in addition to the person mode. Note that in shooting during the night, two situations, that is, night view shooting in which a dark portion is darkly shot and shooting in which a dark object is brightly shot are assumed. The shooting mode may be limited to the night view mode by designating a night view for “what”.

By selecting a shooting method as a keyword for the scenario item “how”, a shooting mode candidate appropriate for the camera shooting method is selected. If, for example, a keyword “preferentially shooting” is selected, a specific object may be set as a shooting object, and thus the person mode and portrait mode are selected as candidates. Alternatively, if a keyword “brightly shooting dark portion” is selected, shooting during the night or in a slightly dark place is assumed, and thus a night mode is selected as a candidate.

The correspondence between each keyword and shooting mode candidates for the keyword has been described.

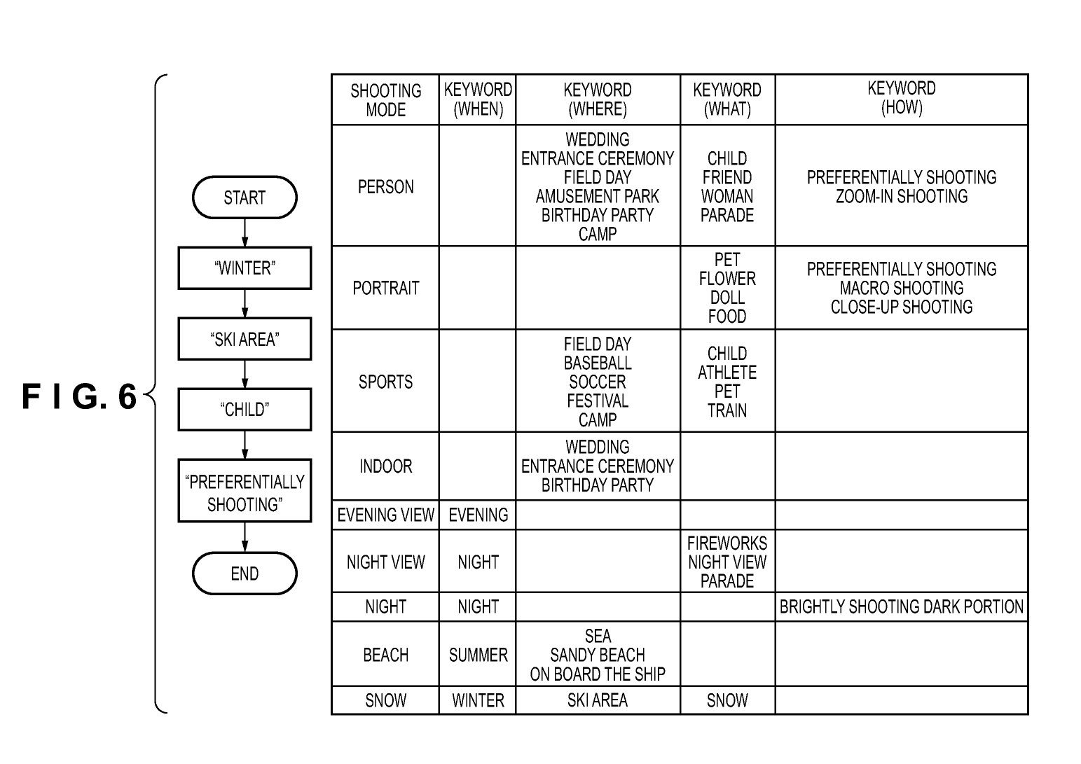

FIG. 6 shows the shooting mode candidates decided by analyzing the scenario data in the aforementioned example. Consider, for example, a case in which the user selects “winter” for “when”, “ski area” for “where”, “child” for “what”, and “preferentially shooting” for “how to shoot”. In this case, as shooting mode candidates, the snow mode is selected based on the keywords “winter” and “ski area”, the sports mode and person mode are selected based on the keyword “child”, and the person mode and portrait mode are selected based on the keyword “preferentially shooting”.

The system controller 114 outputs, as shooting mode candidate information, a shooting mode candidate group extracted based on the set keywords to the shooting parameter generator 111.

The scenario data analysis and shooting mode candidate selection processing has been explained so far.

Next, a scene determination unit 112 determines a shooting scene based on an image signal generated using predetermined shooting parameters, for example, the currently set shooting parameters, and sends shooting scene information to the shooting parameter generator 111. As examples of the practical scene determination processing by the scene determination unit 112, a sport scene is determined if the movement of an object is large, a person scene is determined if a face is detected, and a night view scene is determined if a photometric value is small, as described in Japanese Patent Laid-Open No. 2003-344891. Alternatively, since a combined shooting scene such that a human face is detected and a large movement of an object whose face is detected is detected is possible, a scene determination result obtained by combining a plurality of scenes, such as person+sport (movement), is also output as shooting scene information.

The shooting parameter generator 111 then generates shooting parameters based on the shooting mode candidate information input from the system controller 114 and the shooting scene information input from the scene determination unit 112 (step S104). Examples of the shooting parameters are parameters input to the camera signal processor 105, optical system driver 102, and image sensor driver 104. More specifically, the shooting parameters include an AE program diagram (shutter speed and aperture value), photometry mode, exposure correction, white balance, and image quality effects (color gain, contrast (γ), sharpness (aperture gain), and brightness (AE target value)). Generation of shooting parameters for each shooting mode conforms to the function of a conventional camera or video camera, and a detailed description thereof will be omitted. In, for example, the sports mode, the AE program diagram is set to a high speed shutter-priority program, the photometry mode is set to partial photometry which only measures light of a small region including a screen center or focus detection point, the exposure correction is set to ±0, the white balance is set to “AUTO”, and the image quality effects are turned off.

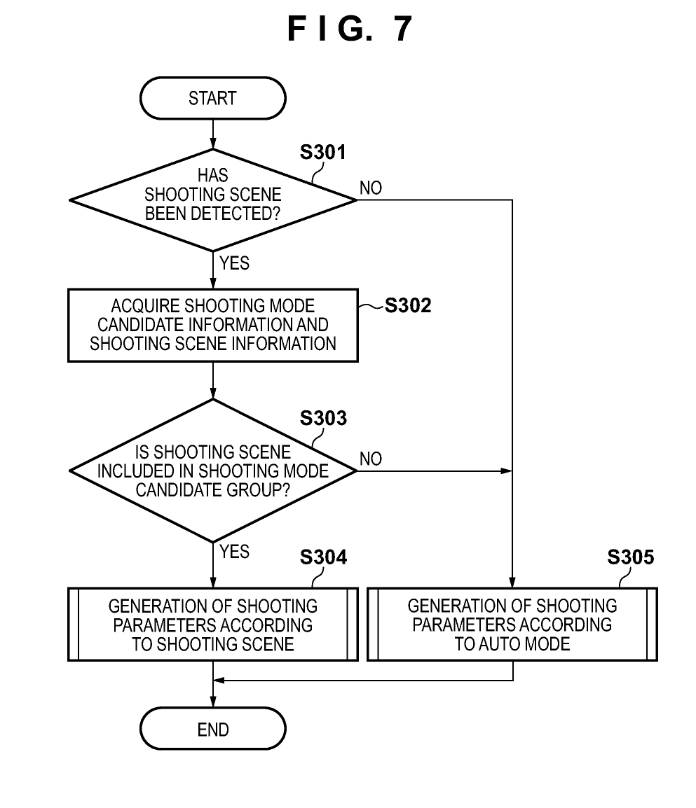

The detailed procedure of the shooting parameter generation processing will be explained below. FIG. 7 is a flowchart illustrating the shooting parameter generation processing.

The shooting parameter generator 111 determines whether the shooting scene information has been received from the scene determination unit 112 (step S301). If the shooting scene information has been received from the scene determination unit 112, the process advances to step S302; otherwise, the process advances to step S305.

In step S302, the shooting mode candidate information is input from the system controller 114 and the shooting scene information is input from the scene determination unit 112. The shooting parameter generator 111 determines whether the shooting mode candidates include a shooting mode corresponding to the input shooting scene information (step S303). A description will be provided with reference to the example of shooting mode candidates shown in FIG. 6. In the scenario shown in FIG. 6, the snow mode, sports mode, and person mode are shooting mode candidates. If the input shooting scene information indicates the person scene, sport scene (the large movement of an object), or snow scene, the shooting mode candidates include them. In this case, therefore, a corresponding shooting mode is selected, and shooting parameters appropriate to the shooting scene are generated (step S304). If the input shooting scene information indicates a combined shooting scene such as “person+sport (movement)” or “snow+sport”, a plurality of corresponding shooting modes are selected, and shooting parameters appropriate to the shooting scene are generated according to the combination of the shooting modes.

Note that shooting parameter generation processing for a shooting scene obtained by combining a plurality of shooting scenes is implemented by shooting parameter generation processing according to the combination of a plurality of shooting modes, as described in Japanese Patent Laid-Open No. 2007-336099.

Consider a case in which the input shooting scene information indicates a shooting scene such as a sunset which does not correspond to any of the above three shooting modes, or a shooting scene such as “person+sunset” obtained by combining a shooting scene which corresponds to one of the above three shooting modes and a shooting scene which does not correspond to any of the three shooting modes. In this case, it is determined that the input scene is inappropriate, and shooting parameters are generated based on an auto shooting mode as a default shooting mode (step S305). If it is determined in step S301 that no shooting scene information has been received from the scene determination unit 112, shooting parameters are also generated base on the auto shooting mode in step S305.

Note that a smooth change in image quality, which is more appropriate for movie shooting, may be realized by performing, for shooting parameters to be generated, hysteresis control according to the transition direction of the shooting scene information, and thereby suppressing a sudden change in image quality due to a change in shooting scene.

The detailed procedure of the shooting parameter generation processing has been described so far.

The shooting parameters generated by the shooting parameter generator 111 are then input to the camera signal processor 105, optical system driver 102, and image sensor driver 104. The system controller 114 controls an imaging system using the shooting parameters generated by the shooting parameter generator 111.

The shooting control procedure in scenario setting has been explained above. The aforementioned arrangement and control reduce the possibility of error determination of a shooting scene, thereby realizing shooting by preferable camera control reflecting user's intention.

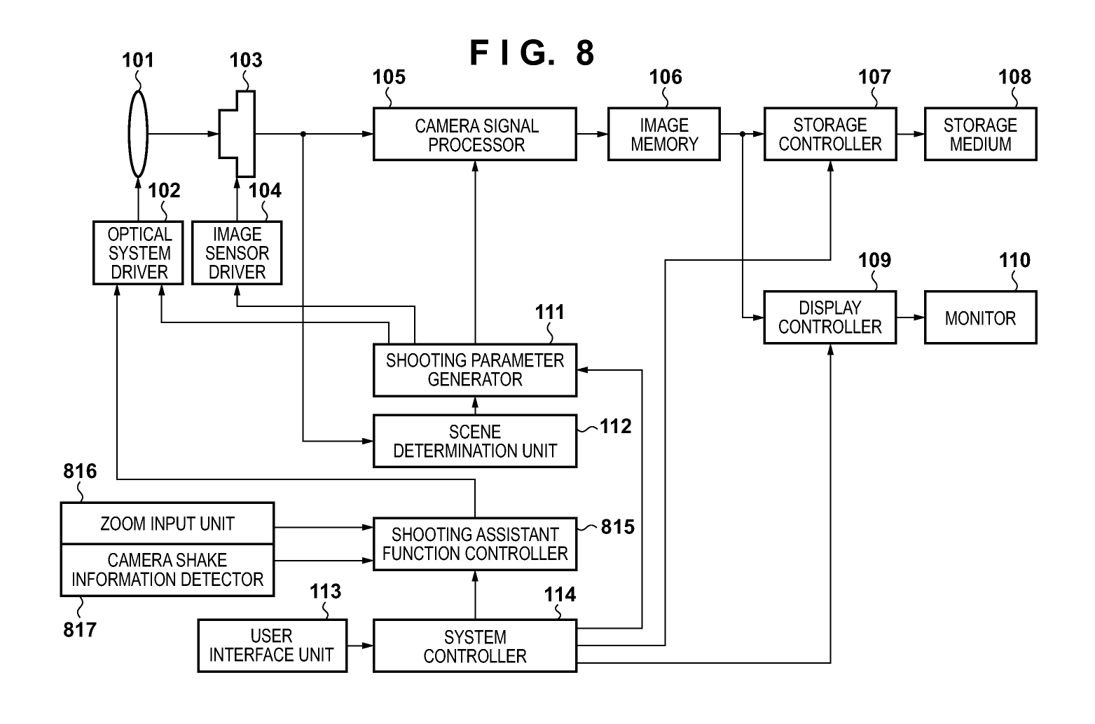

FIG. 8 is a block diagram showing an example of the arrangement of an image capturing apparatus according to another embodiment. In FIG. 8, the same components as those in FIG. 1 have the same reference numerals and a description thereof will be omitted. Referring to FIG. 8, a shooting assistant function controller 815, a zoom input unit 816, and a camera shake information detector 817 are added, as compared with FIG. 1. In this example, the shooting assistant function controller 815 executes control associated with a zoom function and image stabilization function. The shooting operation of the image capturing apparatus with the arrangement shown in FIG. 8 is the same as that described above and a description thereof will be omitted.

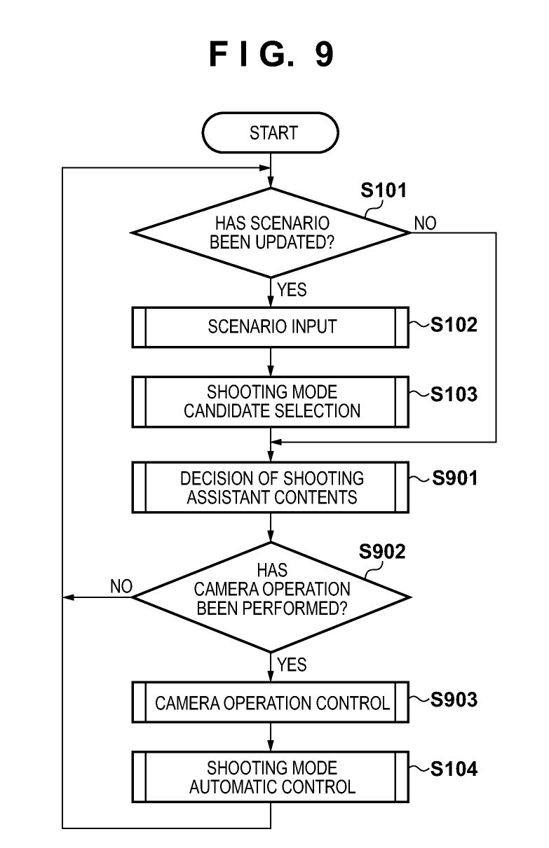

A shooting control procedure in scenario setting in the image capturing apparatus with the arrangement shown in FIG. 8 will be described below with reference to FIG. 9. Referring to FIG. 9, the same processing blocks as those in FIG. 2 have the same reference symbols, and a description thereof will be omitted. The main difference from the shooting control procedure shown in FIG. 2 is that shooting assistant content decision processing is added after shooting mode candidate selection processing (step S103). In the shooting assistant content decision processing, scenario data input from a user interface unit 113 is analyzed, and a shooting assistant function to be used is decided. In this example, camera control is also executed by taking into account decided shooting assistant contents, in accordance with camera operation contents.

If a scenario update instruction has been issued (YES in step S101), a scenario is input (step S102), and shooting mode candidates are selected (step S103).

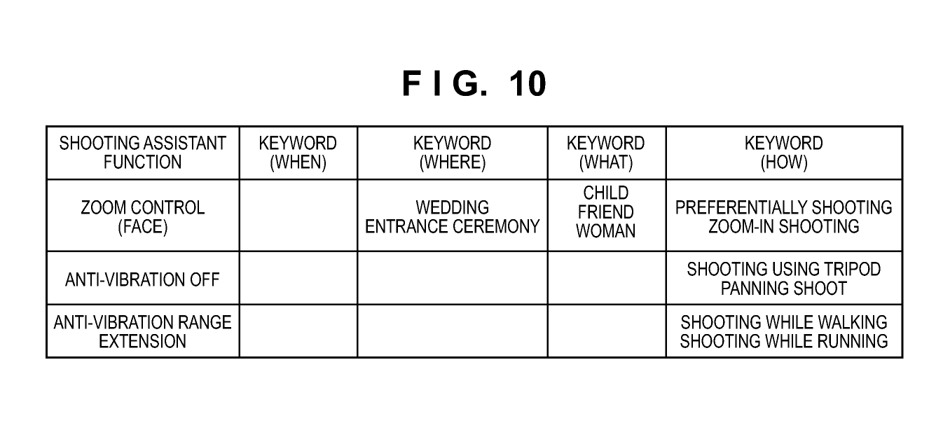

If the shooting mode candidates are selected, a system controller 114 decides shooting assistant contents (step S901). FIG. 10 is a correspondence table between keywords input in the scenario input processing and a shooting assistant function selected for the keywords. A table showing the correspondence between keywords and shooting assistant functions as shown in FIG. 10 is generated by deciding, in advance, shooting assistant function candidates based on a shooting object estimated based on keywords, a shooting time, and required camera works, and is stored in a ROM or the like. The system controller 114 then accesses the ROM storing the correspondence using an input keyword as an address, thereby deciding a shooting assistant function to be used.

Note that the image capturing apparatus according to the embodiment incorporates, as shooting assistant functions, shift lens control (image stabilization) functions “anti-vibration amount increase (anti-vibration range extension)” and “anti-vibration invalidation (anti-vibration off)”, and a zoom control function “zoom control (face)”. If, for example, the user selects “shooting while walking” for “how”, the “anti-vibration amount increase” function is selected to cope with shooting while walking.

Each shooting assistant function according to this embodiment will be described.

The anti-vibration amount increase function will be described first. This function is used to correct a large camera shake in, for example, shooting while walking, by increasing the maximum stabilization angle of image stabilization. The anti-vibration invalidation function will be explained next. This function is used not to perform anti-vibration processing. When no camera shake occurs by, for example, using a tripod, this function prevents a change in image quality due to image stabilization.

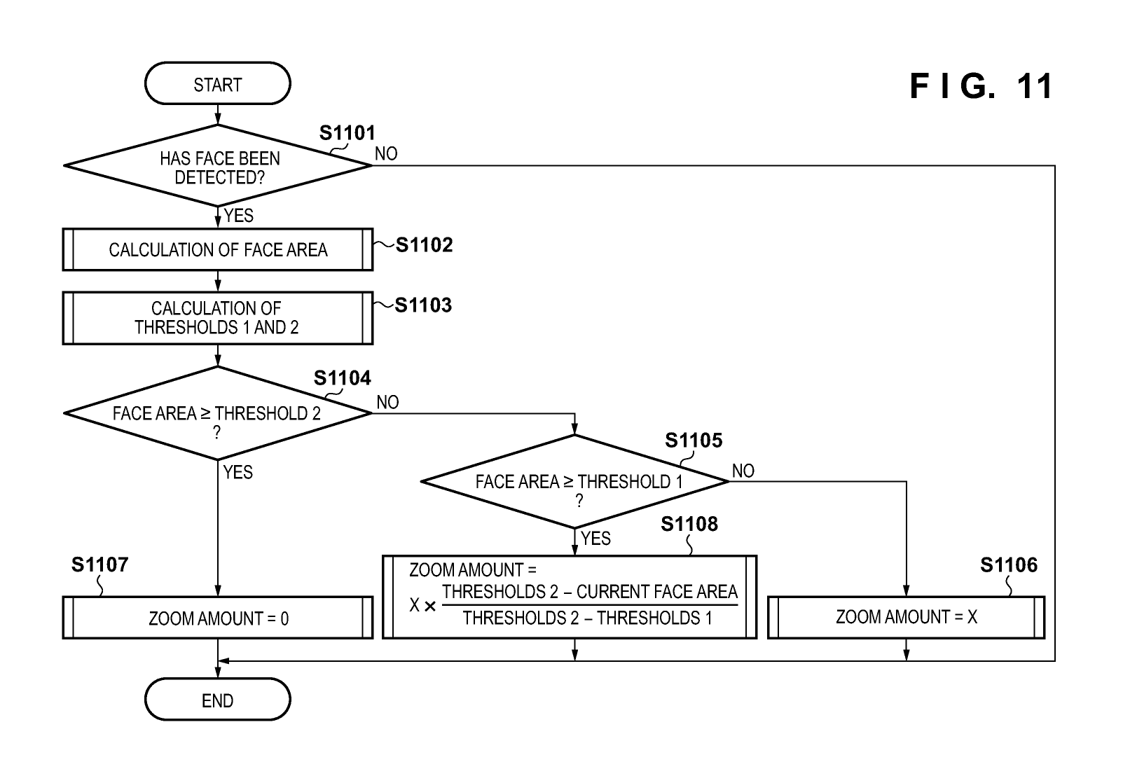

The zoom control (face) function will now be described. Assume that a detected face is zoomed in. In this case, this function is used to stop zooming when the area of the detected face exceeds a specific value. FIG. 11 shows the control procedure of the zoom control (face) function. It is determined whether a face has been detected (step S1101). If a face has been detected, the area of the detected face is calculated (step S1102). Thresholds 1 and 2 to be used to determine zoom control are calculated based on the face area and the current zoom value (step S1103). Threshold 2 indicates a maximum area obtained by zooming in the detected face, which is recognized as a face, given by:

$$threshold 2 = \frac{detectable maximum face area}{( \frac{face area upon detection}{zoom value upon detection} )} \qquad ( 1 )$$

To achieve smooth zoom stop control appropriate for movie shooting, the zoom amount of a zoom actuator is gradually decreased. Threshold 1 represents a face area for which zoom amount control starts.

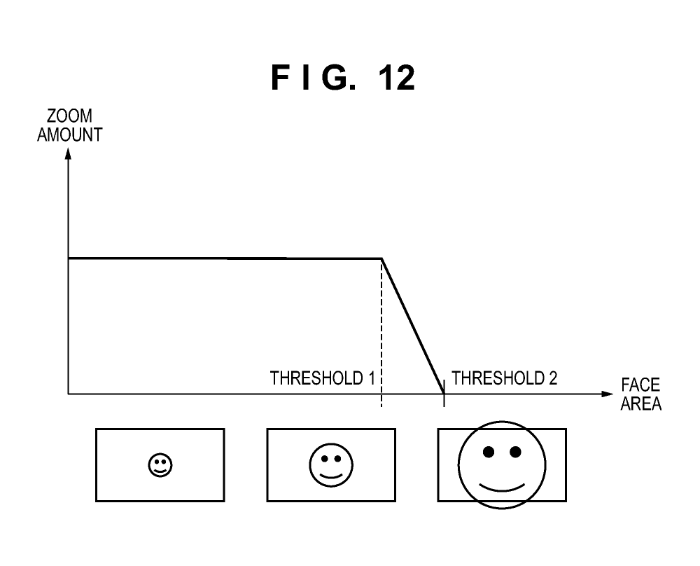

FIG. 12 is a graph showing zoom control (face). The abscissa represents the face area and the ordinate represents the zoom amount. Calculation equations of the zoom amount based on the graph are: if face area<threshold 1: zoom amount=X if threshold 1≦face area<threshold 2:

$$zoom amount = X \cdot \frac{threshold 2 - current face area}{threshold 2 - threshold 1} \\ if face area \geq threshold 2 \text{:} zoom amount = 0 \qquad ( 2 )$$

That is, if the face area is smaller than threshold 1 (NOs in steps S1104 and S1105), the zoom amount X corresponding to a value input from the zoom input unit 816 is set (step S1106). On the other hand, if the face area is equal to or larger than threshold 2 (YES in step S1104), the zoom amount is set to 0. If the face area is smaller than threshold 2 (NO in step S1104) and is equal to or larger than threshold 1 (YES in step S1105), the zoom amount is set to a value corresponding to the value of a face area on a straight line connecting the zoom amount X when the face area is equal to threshold 1 with a zoom amount of 0 when the face area is equal to threshold 2 (step S1108).

This function makes it possible to optimally zoom in on a face as a zoom target, and prevent a change in image quality due to the disappearance of the face by the zoom operation.

In this embodiment, the zoom control function has been explained with respect to a face. For example, it is possible to implement a similar zoom control function for an object (pet or the like) which is recognizable like a face.

The shooting assistant functions according to this embodiment have been described.

If a camera operation such as a zoom operation is performed or movement of a camera such as a camera shake occurs (step S902), camera operation control (step S903) and shooting mode automatic control (step S104) are executed.

Based on the zoom value input from the zoom input unit 816 according to the shooting assistant function selected based on the scenario, the shooting assistant function controller 815 generates a zoom parameter to be input to the zoom actuator of an optical system driver 102. Based on camera shake information input from the camera shake information detector 817, the shooting assistant function controller 815 also generates a shift lens parameter to be input to the shift lens actuator of the optical system driver 102. In this embodiment, by setting the generated shift lens parameter in the shift lens actuator, a lens position is controlled to perform image stabilization. The camera shake information detector 817 calculates camera shake information based on angular velocity information obtained from an angular velocity detector represented by a gyro sensor, as described in, for example, Japanese Patent Laid-Open No. 6-194729.

Shooting parameters generated by a shooting parameter generator 111 are input to a camera signal processor 105, the optical system driver 102, and an image sensor driver 104. The zoom parameter and shift lens parameter generated by the shooting assistant function controller 815 are input to the optical system driver 102, and the zoom actuator and shift lens actuator of the optical system driver 102 operate based on the parameters.

The shooting control procedure in scenario setting has been described above. The aforementioned arrangement and control reduce the possibility of error determination of a shooting scene, thereby realizing shooting by preferable camera control and camera works reflecting user's intention.

Note that the camera shake information may be a motion vector obtained by the difference between two frames, as described in, for example, Japanese Patent Laid-Open No. 5-007327. As an image stabilization method, the readout location of an image stored in a memory may be changed based on the camera shake information, as described in, for example, Japanese Patent Laid-Open No. 5-300425.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-206313, filed Sep. 19, 2012, which is hereby incorporated by reference herein in its entirety.

What is claimed is:

1. An image capturing apparatus which includes an imaging unit configured to generate an image signal by causing an image sensor to photoelectrically convert an object image formed by an imaging optical system, and is capable of operating said imaging unit in a plurality of shooting modes, comprising:
a setting unit configured to set at least one keyword related to a shooting scene, which has been designated by a user;
a selection unit configured to select at least one of the plurality of shooting modes, which corresponds to the at least one set keyword;
a determination unit configured to determine a shooting scene based on the image signal generated by said imaging unit;
a generation unit configured to generate shooting parameters based on the at least one selected shooting mode and the determined shooting scene; and
a control unit configured to control an operation of said imaging unit using the generated shooting parameters.

2. The apparatus according to claim 1, wherein
if a shooting mode corresponding to the determined shooting scene is included in the at least one selected shooting mode, said generation unit generates shooting parameters based on the corresponding shooting mode, and
if the shooting mode corresponding to the determined shooting scene is not included in the at least one selected shooting mode, said generation unit generates shooting parameters based on an auto shooting mode as a default shooting mode.

3. The apparatus according to claim 1, wherein the at least one keyword includes keywords related to a shooting date, a shooting location, a shooting object, and a shooting method.

4. The apparatus according to claim 3, wherein
said setting unit includes
a unit configured to display an item selection screen for prompting the user to select one of a plurality of scenario items related to a shooting date, a shooting location, a shooting object, and a shooting method, and
a unit configured to display a keyword selection screen for prompting the user to select one of a plurality of keyword candidates corresponding to the scenario item selected by the user via the item selection screen.

5. The apparatus according to claim 1, further comprising
a shooting assistant unit including at least one of a zoom function by the imaging optical system, and an imaging stabilization function of correcting a shake of said image capturing apparatus, and
a shooting assistant function control unit configured to control said shooting assistant unit according to the at least one keyword set by said setting unit.

6. A control method for an image capturing apparatus which includes an imaging unit configured to generate an image signal by causing an image sensor to photoelectrically convert an object image formed by an imaging optical system, and is capable of operating the imaging unit in a plurality of shooting modes, the method comprising the steps of:
setting at least one keyword related to a shooting scene, which has been designated by a user;
selecting at least one of the plurality of shooting modes, which corresponds to the at least one set keyword;
determining a shooting scene based on the image signal generated by the imaging unit;
generating shooting parameters based on the at least one selected shooting mode and the determined shooting scene; and
controlling an operation of the imaging unit using the generated shooting parameters.
